(19) United States
(12) Patent Application Publication
(10) Pub. No.: US 2015/0153217 A1
(43) Pub. Date: Jun. 4, 2015

(54) STORAGE DEVICE FOR ARTICLES HAVING A LOAD STATE DETECTION DEVICE FOR DETECTING A REMOVAL, A LOADING AND/OR THE LOAD STATE OF THE STORAGE DEVICE

(71) Applicants: Richard Dillon, Salzburg (AT); Philipp Herzog, Hallwang (AT); Werner Wolf, Aflenz/Kurort (AT)

(72) Inventors: Richard Dillon, Salzburg (AT); Philipp Herzog, Hallwang (AT); Werner Wolf, Aflenz/Kurort (AT)

(73) Assignee: Red Bull GmbH, Fuschl am See (AT)

(21) Appl. No.: 14/389,367

(22) PCT Filed: Mar. 29, 2012
(86) PCT No.: PCT/EP2012/001384

§ 371 Date: Feb. 19, 2015

(51) Int. Cl. G01G 19/52

(52) U.S. Cl. CPC G01G 19/52

(57) ABSTRACT

The present disclosure relates to a system comprising a storage device for articles and a load state detection device, wherein the load state detection device comprises at least one weighing apparatus and at least one evaluating device, wherein the weighing apparatus is designed and configured to detect measured values representative of a weight of the storage device and the evaluating device is designed and configured to determine the weight of the storage device based on the measured values of the weighing apparatus. The weight of the storage device is determined when the measured values of the weighing apparatus are not affected by devices of the storage device. The present disclosure further relates to a computer network having at least one such storage device and to a method for determining a load state of a storage device.

### BACKGROUND

The present disclosure relates to a storage device for articles having a load state detection device, wherein the load state detection device comprises at least one weighing apparatus and at least one evaluating device, to a computer network having such a storage device and a method for determining a load state of such a storage device.

### SUMMARY AND INITIAL DISCLOSURE

Storage devices are known in the state of the art in the form of shelves, refrigerators, cupboards and the like, and storage devices are used both in private households and in shops, for example, to store articles and present them for sale.

A special type of storage devices are refrigeration appliances. Refrigeration appliances or refrigerators are known in the state of the art in various embodiments. In addition to classic refrigerators for domestic use, chest freezers, refrigerated display cabinets, minibars, and the like are known, for example, that can either be closed by way of a door or are open and will hereinafter all be referred to as refrigeration appliances.

For example, from DE 10 2007 032 052 A1 a device for regulating the power consumption of an electrical appliance is known, wherein information provided by the electrical appliance, for example, by temperature measurement devices of a refrigerator, can be sent to a control device.

JP 2006 345 144 A describes a monitoring device for appliances that comprises at least one sensor for detecting that the appliance is opened or closed, a vibration, a sound, and further data, wherein the monitoring device can transmit data of the appliance to other appliances by way of a data transmission device.

Detection systems for detecting a load state of a storage device are also known in the state of the art. From WO 2005/015510 A1, a detection device having a sensor arrangement is known that may, for example, comprise piezoelectric weight sensors, a digital image recording system, infrared switches, and/or laser sources having digital detectors for detecting a load state of a refrigeration appliance.

WO 2007/128572 describes a system for monitoring a storage of articles, wherein the system comprises a sensor for monitoring the opening or closing of a door and at least one weight sensor, wherein the system comprises a plurality of containers and each container is in operative connection with a weight sensor, and wherein the weight of a container is measured at a predefined time after the door of the container is closed.

From DE 20 2008 015 892 U1, a container having an RFID sensor for detecting an article provided with an RFID chip is known, wherein the container detects that an article is removed from or placed in the container, and wherein a weighing apparatus additionally measures the weight difference caused by removing an article from or placing an article in the container.

DE 10 2005 054 333 A1 discloses a refrigeration appliance having a plurality of storage places for articles to be stored in a storage compartment as well as a detection device for detecting the load state of a storage compartment, wherein the detection device has at least one separate sensor for detecting the state of occupation of each of the storage places in the storage compartment. Each of said sensors comprises a capacitor that is arranged such that a change in the state of occupation of the storage place associated with the sensor causes the capacity of the capacitor to change.

From DE 10 2005 052 952 A1, a refrigeration unit having a goods compartment for industrially manufactured refrigerated products is known, wherein the refrigeration unit comprises a load cell that is arranged below the refrigeration unit and has a strain gauge for measuring the weight of the refrigeration unit.

From EP 1 152 315 A2, a device and a method for monitoring and controlling a temperature of a refrigeration appliance are known, wherein the system comprises a temperature sensor and information of the refrigeration appliance is transmitted to a data processing device by way of a wireless data transmission device.

However, the state-of-the-art detection systems for detecting a state of occupation of a refrigeration appliance have the drawback that the storage device needs to comprise complex technical measures, for example a plurality of sensors, to be able to determine which type of article and how many such articles is/are removed from or placed in the storage device. In the state of the art, an individual load state detection device is provided for each article or each group of articles in order to determine the load state of a storage device. As an alternative of the state of the art, the articles themselves are provided with an identification, for example, an RFID chip, that can be detected by a special evaluating device in order to determine the load state of a storage device.

This means that, according to the state of the art, complex load state detection devices or individual, additional identifications of the articles and special evaluating devices are required to precisely identify the articles that are removed, placed and/or stored.

In general, it is known in the state of the art to determine the load state of a storage device of a refrigeration unit by measuring its weight. However, in the state of the art the load state can only be determined if the storage device is loaded with one particular type of article, and no differentiation can be made between individual batch sizes or container sizes. It can only be determined that a particular amount of one type of article is removed from the storage device or placed in the storage device.

However, according to the state of the art it is not sufficient to detect only the weight of a storage device to be able to determine which type of article and how many such articles is/are present in the storage device, or to measure only weight differences to be able to precisely identify an article that is removed or placed.

At least one object of the present disclosure is therefore to eliminate the drawbacks of the state of the art. In particular, it is intended to provide a storage device that allows to precisely determine the load state of the storage device as well as to precisely determine which type of article and how many such articles is/are removed from or placed in the storage device by measuring the weight of the storage device alone.

This objective is achieved due to the fact that the weighing apparatus is designed and configured to detect measured values representative of a weight of the storage device, and the evaluating device is designed and configured to determine the weight of the storage device based on the measured values of the weighing apparatus, wherein the weight of the storage device is determined when the measured values of the weighing apparatus are not affected by devices of the storage device.

This has the advantage that it is possible to precisely measure the weight of the storage device and hence to determine a load state of the storage device with different products. To be able to determine the load state of a storage device with at least two different products, very precise measured values of the weight of the storage device are required. However, devices of the storage device may affect the weighing apparatus. For example, the vibrations of a compressor of a refrigerator affect the result of the weight measurement. It is thus advantageous for determining the load state of a storage device that the measured values of the weighing apparatus are not affected by devices of the storage device.

In this context, it may be preferred that the weighing apparatus comprises at least one weighing scale, in particular a mechanical, electronic and/or electromechanical weighing scale.

Also, the evaluating device may be designed in the form or as part of a data processing unit, in particular a computer.

In this context, the weighing apparatus may also be designed and configured to detect the weight of the storage device within a weighing range from 0 kg to 200 kg with a measurement accuracy in a range from one nanogram to one gram, particularly preferred in a range from one nanogram to one microgram.

In this context, it may be preferred that the weighing apparatus comprises at least one load cell, preferably four load cells, wherein each of the load cells comprises at least one strain gauge, in particular four strain gauges, that are arranged in the form of a bridge circuit, preferably a Wheatstone bridge.

Also, the load cells may be arranged below the storage device, preferably in the area of feet of the storage device, between the feet of the storage device and the storage device and/or underneath the feet of the storage device.

According to the present disclosure, it may be possible to determine a load state of the storage device with articles, or said load state may be determined, based on the weight of the storage device, wherein, based on a change in weight of the storage device, it can be determined or is determined, in particular, that an article is removed from the storage device and/or an article is loaded into the storage device.

Also, at least one memory may be comprised that is designed and configured to store the time when at least one article is removed from and/or loaded into the storage device.

In this context, at least one memory may be comprised in order to store the number of articles that are removed during a removal and/or the number of articles placed in the storage device when it is loaded.

Also, the storage device may be designed and configured to store at least one article in the form of a food item, in particular a beverage, preferably a beverage can and/or a bottle.

Also, it is preferred that the storage device comprises a data processing device, in particular a computer, and/or a memory, wherein the evaluating device and the data transmission device are preferably designed as one unit.

According to the present disclosure, the storage device may also comprise a data transmission device, in particular for transmitting data via a wire-based or wireless computer network and/or using a mobile communication standard, preferably a GSM and/or UMTS standard.

In this context, the storage device may be in operative connection with a server, and in particular the storage device may be designed and configured to send data from the storage device to the server and/or to retrieve data from the server and/or to send data from the server to the storage device and/or to retrieve data from the storage device, and/or the server may be in operative connection with at least one further appliance, in particular a further storage device, a home appliance, such as a cooking appliance, a computer, a mobile phone and/or a tablet computer.

Also, at least one display device may be comprised that is designed and configured such that the server displays and/or provides data from the storage device on the display device, in particular automatically, preferably by way of an e-mail, a push message, an SMS and/or an MMS.

In this context, it may be preferred that the storage device comprises at least one input device, in particular a keyboard, a touch screen and/or a mouse, and/or that the storage device comprises at least one device for receiving data, in particular a device for receiving data that is designed and configured to receive data from an external server, and/or that the storage device comprises a display device, in particular a display.

Also, the storage device may comprise at least one position detection device, in particular a GPS receiver and/or a device for cell site location tracking.

Also, the position detection device may be designed and configured to detect a change of an actual position of the storage device and preferably to transmit the actual position of the storage device to the server.

Furthermore, it may be preferred that the position detection device is designed and configured to compare the actual position of the storage device with a predefined desired position, and that in particular a difference between the actual position and the desired position can be displayed or is displayed to a user on the display device of the storage device, and/or that an e-mail, a push message, an SMS, and/or an MMS can be sent from the storage device and/or the server to at least one data processing device and/or at least one terminal, in particular a mobile terminal.

In this context, a desired position of the storage device may be stored in the memory of the storage device, and preferably it may be possible to define and/or change the desired position, in particular by way of the input device of the storage device and/or of the server.

According to the present disclosure, it may also be preferred that the storage device comprises an operating state detection device for detecting an operating state of the storage device, wherein the operating state detection device is preferably designed and configured to detect whether the storage device is switched on or switched off, maintenance work is taking place or due to take place and/or the storage device is malfunctioning or at fault.

It is also preferred that the operating state of the storage device can be displayed on the storage device by way of the display device and/or can be retrieved from the server and/or can be sent to the server, in particular in real time.

In this context, a desired operating state may be stored in a memory, and preferably it may be possible that the desired operating state is defined and/or changed by a user, preferably in accordance with a date and/or a time of day, in particular by way of an input device of the storage device.

Also, the data processing device of the storage device may be designed and configured to compare the actual operating state with a predefined desired operating state, and it may in particular be possible to display a difference between the actual operating state and the desired operating state, or said difference may be displayed, to a user on the display device of the storage device, and/or it may be possible to send an e-mail, a push message, an SMS, and/or an MMS to at least one data processing device and/or at least one terminal, in particular a mobile terminal.

In this context, it may be preferred that the difference between the actual operating state and the desired operating state can be transmitted to the server, and that preferably the server can be displayed or is displayed to a user by way of a display device, and/or that an e-mail, a push message, an SMS and/or an MMS can be sent to at least one data processing device and/or at least one terminal, in particular a mobile terminal.

Also, it may be preferred that the storage device comprises at least one temperature measurement device, wherein the at least one temperature measurement device is designed and configured to detect the temperature at least in an area of the storage device, and that the storage device preferably comprises at least two temperature measurement devices, wherein at least one first temperature measurement device is designed and configured to detect at least one first temperature in a first area of the storage device and at least one second temperature measurement device is designed and configured to detect at least one second temperature in a second area of the storage device.

In particular, the display device of the storage device may be designed and configured to display at least one temperature that has been measured, and/or it may be possible to retrieve the at least one temperature measured from the server and/or to send said temperature to the server, in particular in real time, and preferably the at least one temperature measured may be stored in the memory at intervals, preferably regular intervals.

Also, it may be preferred according to the present disclosure that the storage device comprises at least one user detection device, in particular at least one motion detector, at least one infrared sensor and/or at least one radar module.

In this context, the user detection device may be designed and configured to scan an area in front of and/or adjacent to a front side of the storage device, preferably an area of 180°, in particular in front of a reach-in area for removing articles from and/or loading articles into the storage device.

An integration of a user detection device into a storage device has in particular the advantage that the behavior of a user can be precisely detected. This is particularly advantageous as it allows to determine at which times articles are removed from the storage device. Based on this data, it can then, for example, be determined according to the present disclosure on which days of the week and at which times more products and which types of products are removed in order to optimize restocking of the storage device based on a load state of the storage device. A user detection device according to the present disclosure can thus serve to optimize the supply chain of the storage device with products, thus ensuring that the user detection device is sufficiently loaded at all times.

In this context, a desired operating state may also be stored in a memory, and preferably it may be possible to define and/or change the desired operating state, preferably in accordance with a date and/or a time of day, in particular by way of an input device of the storage device.

According to the present disclosure, it may also be preferred that the user detection device of at least one of the storage devices is arranged in the upper half, preferably on the front side, of the storage device, in particular in a cover area, preferably above the reach-in area of the storage device.

In this context, it may be possible to retrieve data of the user detection device from the external server and/or to send said data to the external server, in particular in real time.

In particular, it may be preferred that the user detection device is designed and configured to detect a time period of at least one user in front of the storage device.

Also, it may be preferred that the user detection device is at least designed and configured to detect a time period from a start of operation, restart of operation, a previous loading of and/or previous removal from the storage device until the next time when at least one article is removed from and/or loaded into the storage device by the at least one user and/or operation stops, and/or to detect a time period of at least one user in front of the storage device without removal from and/or loading of the storage device, wherein the load state detection device can detect or detects that something is loaded into and/or removed from the storage device.

In this context, the memory of the storage device may be designed and configured to store reference values of the weight of at least one article, in particular of a plurality of articles.

According to the present disclosure, the storage device may in particular also comprise a storage device parameter representative of an installation site, a country, a customer group, a dealer, a dealer group and/or an identification number.

In this context, it may advantageously be preferred that it is possible to send data relating to at least one storage device parameter and/or from at least one user detection device, at least one load state detection device, at least one temperature measurement device, at least one operating state detection device, at least one evaluating device and/or at least one position detection device to the server and/or to retrieve said data from the server, in particular continuously or at intervals, in particular regular intervals, in particular intervals of 30 minutes and/or 60 minutes, and/or to display and/or store said data in accordance with a day, a time of day, a week, a year, an installation site, a customer, a country, a town/city, and/or the like.

Also, the storage device may be designed in the form of a refrigeration appliance, in particular a refrigerator, wherein the refrigeration appliance preferably comprises a refrigeration device.

In particular, a data processing device may be comprised that is designed and configured to detect and/or store an operating time of the refrigeration device, and it may in particular be possible to send the operating time to the server and/or retrieve the operating time from the server.

In this context, it may be preferred that the weight of the storage device is only determined when the measured values of the weighing apparatus are not affected by devices of the storage device and/or if the evaluating device is designed and configured to compensate for effects of the devices of the storage device on the measuring device, in particular by way of statistical algorithms.

Also, the weight of the refrigeration appliance may be determined when a refrigeration device of the refrigeration appliance is not operating, and/or the refrigeration appliance may comprise a decoupling device, wherein the decoupling device is designed and configured to mechanically decouple the weighing apparatus from the refrigeration device, so that in particular vibrations of the refrigeration device will not affect the weighing apparatus, and/or the refrigeration appliance may be designed in the form of a compressor refrigerator, an absorption refrigerator and/or a thermoelectric refrigerator, wherein the refrigerator preferably comprises at least one refrigeration device in the form of a compressor, wherein in particular no data of the weighing apparatus is evaluated by the evaluating device when the compressor is active, and/or an analogue and/or digital filter is comprised that is designed and configured to filter effects of the compressor on the load state detection device.

In particular, the storage device may also comprise a holding device for food items, in particular beverages, preferably beverage cans and/or bottles.

Also, it may be preferred that the storage device has at least one open storage area, in particular an open refrigerated area, and in particular no door for closing the refrigerated area.

Finally, the refrigeration appliance may also comprise at least one temperature measurement device that detects the temperature in a refrigerated area of the refrigeration appliance, and it may preferably be possible to display the temperature that has been measured, or said temperature may be displayed, by way of the display device of the refrigeration appliance, and/or to retrieve said temperature from the server and/or to send said temperature to the server, in particular in real time.

The present disclosure also provides a computer network comprising at least one storage device according to the present disclosure and at least one server.

A network of storage devices according to the present disclosure can allow optimization of supply chains of products for the storage devices. In this context, it can advantageously be detected at which time and in which place products are removed from one of the storage devices or products are loaded into the storage devices. This allows optimization of the necessary logistics processes. In addition, it can be detected in which places there is a higher demand for particular products, and this information can be used for future planning of the supply processes.

Also, it is preferred that the server is in operative connection with at least one input device and/or at least one output device, preferably at least one display device, in particular at least one mobile terminal, preferably a mobile phone.

Also, the server may receive and/or retrieve data from at least one storage device, in particular automatically, preferably at regular intervals, wherein at least one of the storage devices transmits data from a user detection device, a temperature measurement device, an operating state detection device, relating to a storage device parameter and/or from a position detection device to the server.

Finally, it is preferred that the server sorts and/or stores the data in accordance with an installation site, a country, a customer group, a dealer, a dealer group and/or an identification number and in particular displays said data on an output device.

The present disclosure also provides a method for determining a load state of a storage device according to the present disclosure, wherein measured values representative of a weight of the storage device are detected by a weighing apparatus and the measured values are evaluated by an evaluating device, wherein the measured values are not evaluated when the measured values of the weighing apparatus are affected by devices of the storage device.

In this context, the weight of the storage device may be detected within a weighing range from 0 kg to 200 kg with a measurement accuracy in a range from one nanogram to one gram, particularly preferred in a range from one nanogram to one microgram.

Also, it may be preferred that the weighing apparatus comprises at least one load cell, in particular four load cells, wherein each of the load cells comprises at least one strain gauge, preferably four strain gauges, that are arranged in the form of a bridge circuit, preferably a Wheatstone bridge.

In particular, the load cells may be arranged below the storage device, preferably in the area of feet of the storage device, in particular between the feet of the storage device and the storage device and/or underneath the feet of the storage device.

According to the present disclosure, a load state of the storage device with articles may be determined based on the weight of the storage device, wherein, based on a change in weight of the storage device, it is in particular determined that an article is removed from the storage device and/or an article is loaded into the storage device.

Also, it is preferred that the time when at least one article, in particular one and/or several beverage cans and/or bottles, is removed from and/or loaded into the storage device is stored in a memory, preferably the number of articles that are removed during a removal and/or the number of articles loaded into the storage device when it is loaded is stored in the memory.

Also, a data transmission device may be provided, in particular for transmitting data via a wire-based or wireless computer network and/or using a mobile communication standard, preferably a GSM and/or UMTS standard, and the storage device may in particular be in operative connection with a server, wherein data is preferably sent from the storage device to the server and/or retrieved from the server and/or data is transmitted from the server to the storage device.

Also, it is preferred that data from the storage device is provided on a display device by the server, in particular automatically, in particular that the server automatically sends an e-mail, a push message, an SMS, and/or an MMS containing the data of the storage device.

Also, it is preferred that a change of an actual position of the storage device is detected by way of a position detection device, and the actual position of the storage device is preferably sent to the server.

Also, the actual position of the storage device may be compared with a predefined desired position by the position detection device and/or the server, and in particular a difference between the actual position and the desired position may be displayed on the display device of the storage device, and/or an e mail, a push message, an SMS, and/or an MMS may be sent.

According to the present disclosure, a desired position of the storage device may also be stored in a memory of the storage device in this context, and preferably the desired position may be defined and/or changed, in particular by way of an input device of the storage device and/or of the server.

Also, it is preferred that an operating state of the storage device is detected by way of an operating state detection device of the storage device, wherein it is preferably detected whether the storage device is switched on or switched off, maintenance work is taking place or due to take place and/or the device is malfunctioning or at fault, wherein in particular the operating state of the storage device is displayed on the storage device by way of the display device and/or is sent to the server and/or retrieved from the server, in particular in real time, wherein preferably a desired operating state is stored in a memory and preferably the desired operating state is defined and/or changed.

In particular, the actual operating state of the storage device may also be compared with a predefined desired operating state by the operating state detection device and/or the server, and in particular a difference between the actual operating state and the desired operating state may be displayed to a user on the display device of the storage device, and/or an e-mail, a push message, an SMS, and/or an MMS may be sent to the user.

Also, it is preferred that a temperature of a storage area of the storage device is measured, and that in particular the temperature that has been measured is displayed to a user on a display device of the storage device, and/or the temperature measured is retrieved from the server and/or sent to the server.

Also, a time period from a start of operation, restart of operation, a previous loading and/or previous removal until at least one article is removed from and/or loaded into the storage device by the at least one user and/or operation stops may be detected, and/or a time period of at least one user in front of the storage device without removal from and/or loading of the storage device may be detected, wherein a removal from and/or loading of the storage facility is detected by the load state detection device.

Also, it is preferred that the weight of at least one article, in particular of a plurality of articles, is stored in a memory as a reference value.

Also, at least one storage device parameter may be defined for the storage device, wherein the storage device parameter is selected so as to be representative of an installation site, a country, a customer group, a dealer, a dealer group, and/or an identification number.

According to the present disclosure, data from the user detection device, the temperature measurement device, the operating state detection device and/or the position detection device may also be transmitted to the server at intervals, in particular regular intervals, in particular intervals of 30 minutes or 60 minutes, and/or may be shown and/or stored in accordance with a day, a time of day, a week, a year, an installation site, a customer, a country, a town/city, and/or the like.

In this context, the storage device may be provided in the form of a refrigeration appliance, wherein the refrigeration appliance provides a refrigeration device, and preferably an operating time of the refrigeration device may be detected and/or stored and may in particular be sent to the server and/or retrieved from the server, and preferably the measured values may not be evaluated when a refrigeration device of the refrigeration appliance is operating to effect refrigeration.

Finally, the refrigeration appliance may be operated using a refrigeration device in the form of a compressor, wherein in particular no data of the weighing apparatus is evaluated by the evaluating device when the compressor is switched on to effect refrigeration of the refrigeration appliance, and/or a digital and/or analogue filter is provided in order to filter the effect of the compressor that is switched on.

The present disclosure is thus based on the surprising finding that a load state of a storage device with a plurality of different articles can be determined by precisely determining the weight of a storage device alone. Furthermore, a precise measurement of the change in weight of the storage device allows to determine that an article is removed from the storage device or an article is loaded into a storage device.

To this end, according to the present disclosure a weighing apparatus may continuously detect measured values representative of a weight of the storage device, and an evaluating device, that may preferably be designed in the form of a data processing device, may determine the weight of the storage device based on the measured values of the weighing apparatus. In this context, it has been found to be advantageous that the weight of the storage device is not determined when the measured values of the weighing apparatus are affected by devices of the storage device.

For example, it has been found to be advantageous that the evaluating device of a loading device in the form of a refrigeration appliance does not evaluate data of the weighing apparatus when a refrigeration device of the refrigeration appliance affects the measured values of the measuring device. In this context, only a refrigeration device not comprising a compressor may be used, for example, an adsorption refrigeration device. If a compressor refrigeration device is used, vibrations of the compressor could affect the measured values of the measuring device during operation. In this context, it has been found to be advantageous that in case of a refrigeration appliance having a compressor refrigeration device the measured values are only evaluated at certain times, for example, when a compressor is not operating, or that the compressor is mechanically separated from the measuring device, so that the compressor is supported in particular in a vibration-free manner relative to the measuring device. In both possible configurations according to the present disclosure, the compressor refrigeration device can thus be prevented from affecting the measured values, and it can thus be precisely determined that articles are removed from and loaded into the storage device.

According to the present disclosure, a weighing scale, in particular, a mechanical, electronic, and/or electromechanical weighing scale, may be comprised by the storage device as a weighing apparatus, wherein the weighing apparatus measures or detects the weight of the storage device with a high measurement accuracy. In this context, it may be advantageous that the weighing apparatus has a weighing range from 0 kg to 200 kg with a measurement accuracy in a range from one nanogram to one gram, particularly preferred in a range from one nanogram to one microgram.

Such a precise determination of the weight of the storage device requires that the measured values of the weighing apparatus are not affected by other devices of the storage device; in particular, devices of the storage device that, for example, vibrate must not be active. Such vibrations may distort the measured values of the weighing apparatus. Of course the measured values of the weighing apparatus may also be distorted by other devices of the storage device, so that the measured values of the weighing apparatus should also not be evaluated by the evaluating device when these devices are operating.

A high measurement accuracy according to the present disclosure may, for example, be achieved by way of a weighing apparatus comprising at least one load cell, preferably four load cells, wherein each of the load cells preferably comprises one strain gauge, preferably four strain gauges, that are arranged in the form of a bridge circuit, preferably a Wheatstone bridge. A bridge circuit in the form of a Wheatstone bridge can, for example, allow to precisely measure the weight of the storage device if the electric resistances of the Ohmic kind of the strain gauges are evaluated. In this context, each two strain gauges or their resistors form a voltage divider, and two voltage dividers are arranged parallel to each other. A voltmeter relates the voltage dividers to each other, so that the measured parameter of the arrangement is a voltage difference between the voltage dividers, also referred to as diagonal bridge voltage. This Wheatstone bridge has in particular the advantage that the resistors of the strain gauges that are sensitive to expansion and whose resistance will increase or decrease depending on the deformation of the resistors, complement each other in the same direction. However, temperature changes or the like do not affect the measurement result as they have the same effect on all strain gauges and neutralize each other.

In this context, it is preferred that the load cells and/or the strain gauges of the load cells are arranged below the storage device, in particular in the area of feet of the storage device. In this context, it may be advantageous that the strain gauges are arranged underneath the feet or between the feet and the body of the storage device.

A load state of the storage device may thus be determined based on the weight of the storage device, wherein, based on a change in weight of the storage device, it can be determined, for example, that an article is removed from the storage device and/or an article is loaded into the storage device, wherein it is in particular also possible to determine the type of article and the number of articles.

According to the present disclosure, a load state of the storage device may also be determined directly from the weight of the storage device. In this context, the weights of the articles located in the storage device may advantageously be stored as reference values in a memory of the storage device and/or a memory that is in operative connection with the storage device.

It is also preferred that a change in weight of the storage device is used to determine the type of article that is removed from and/or placed in the storage device and the number of articles concerned. In this context, the change in weight can be compared with the weights of the articles stored as reference values. It is also preferred that the time when something is removed from and/or loaded into the storage device is stored in a memory.

For example, according to the present disclosure articles in the form of food items, in particular in the form of beverage cans or bottles, may be stored in a storage device. When a user, in this exemplary case a consumer, removes, for example, a beverage can from the storage device, the weight of the storage device will change due to the removal of the can. In the memory of the storage device, a reference value for a weight of each type of can located in the storage device is stored, so that the number and type of cans that have been removed can be determined based on the change in weight of the storage device caused by the removal. If a precision weighing apparatus is used, which is preferably comprised by the storage device, not only cans differing in volume can be determined but, due to the different specific weight of different beverages, also the type of beverage that has been removed. For example, it can be detected whether a particular beverage in the can removed from the storage device in the example contains sugar or not as the storage device according to the present disclosure can even detect such small differences between the specific weights of the beverages and thus of the cans. A crucial factor in such a precise measurement of the weight of the storage device is the fact that devices of the storage device do not affect the measured values of the weighing apparatus.

Also, according to the present disclosure the storage device may comprise a data processing device, in particular a computer, wherein the evaluating device and the data processing device may be designed as one unit. In this context, it may be advantageous that the storage device comprises a data transmission device in order to transmit data to a further data processing device, for example, a server, a mobile phone, or the like. Preferably, data may be transmitted from the storage device to a further data processing unit via a wire-based or wireless network and/or using a mobile communication standard, in particular the GSM and/or UMTS standard.

In this context, according to the present disclosure the storage device may also be in operative connection with a server, wherein data can be sent from the storage device to the server and/or retrieved from the server and vice versa. In this context, it may be advantageous that the server is in operative connection with further terminals and/or another server, in particular that the server makes available information or data from the storage device to a user, for example, displays said information or data on an output device and/or transmits a message to the user, for example, in the form of an e-mail, an SMS, an MMS, and/or a push message.

Also, the storage device may comprise an input device that, for example, allows a user to operate the storage device and/or to provide and/or retrieve data and/or information of the storage device. In this context, an input device according to the present disclosure may, for example, be provided in the form of a keyboard, a mouse, a touch screen, and/or the like.

Furthermore, it may be advantageous that the storage device has a position detection device to determine an actual position of the storage device. Such a position detection device according to the present disclosure may, for example, be provided in the form of a GPS receiver and/or a device for cell site location tracking. In this context, a desired position of the storage device may be stored in a memory, and it may be possible at all times to compare the actual position of the storage device with the desired position, and/or said comparison of the actual position with the desired position may be made automatically, for example, in real time and/or at regular intervals. The desired position can be predefined at the discretion of a user and changed when required.

In this context, a difference between the actual position and the desired position of the storage device may be displayed to a user on a display device of the storage device and/or on a display device that is in operative connection with the server, and/or the storage device and/or the server may inform a user of said difference by way of an SMS, an MMS, an e-mail, and/or a push message.

Such a position detection device has in particular the advantage that it allows to display where a storage device is located. If the actual position of the storage device is found to differ from a desired position of the storage device, a user can be informed immediately. An operator of a storage device according to the present disclosure can thus check, for example, whether the storage device continues to be in the desired position in a shop.

According to the present disclosure, the storage device may also comprise an operating state detection device. The operating state detection device can detect whether a storage device is in a switched-on or switched-off state and/or whether the storage device is malfunctioning. In this context, a desired operating state of a storage device may be stored in a memory, and the desired operating state may be compared with an actual operating state continuously and/or at intervals. If the actual operating state is found to differ from the desired operating state, the difference can be displayed to a user by way of a display device, for example, a display device of the storage device and/or a display device that is in operative connection with the server. Of course, a user may also be informed of the difference between the actual operating state and the desired operating state, either additionally or exclusively, by way of an SMS, an MMS, an e-mail, and/or the like. Such an operating state detection device has a number of advantages, some of which will, by way of example only, be explained below.

It can, for example, be defined in a memory at which time of day and on which days a storage device should be operating. Such predefined operating times of the storage device may, for example, be contractually agreed with a dealer. The operator of a storage device can thus check whether a storage device is operating at the agreed times. Also, maintenance and/or a repair of the storage device can be made easier as a service centre and/or a service employee can be immediately informed of a malfunction of the storage device.

Also, a storage device may comprise at least one temperature measurement device to measure the temperature at least in an area of the storage device. Advantageously, two or more temperature measurement devices may also be provided to measure a temperature in particular areas of the storage device. The actual temperatures that have been measured can be compared with desired temperatures stored in a memory, and a user can be informed of differences between the actual temperature and the desired temperature. In this context, the data processing device of the storage device and/or the server may compare an actual temperature with a desired temperature of the storage device, and a user may be informed of the difference. It may be advantageous that the difference between the actual temperature and the desired temperature of the storage device is displayed to a user on a display device, for example, a display device of the storage device and/or a display device that is in operative connection with the server.

This has, among others, the advantage that the temperature of articles that should be stored cool, for example, perishable goods and/or articles that tend to taste better when they are cold, in particular beverages, can be checked. Furthermore, continuous storage of the at least one measured temperature serves to prove that a predefined maximum temperature of the articles located in the storage device has not been exceeded. This may in particular be advantageous in case of food items.

Also, according to the present disclosure the storage device may comprise a user detection device. Said user detection device is preferably arranged above a reach-in area of the storage device and may, for example, comprise a motion detector, a light sensor, an infrared sensor and/or a radar module to detect a user. In this context, a reach-in area can be the area of a storage device that allows a user to place articles in or remove articles from the storage device. It may be possible to close the reach-in area, for example, by way of a door. The user detection device thus serves to determine whether and how long a user is or has been in front of a storage device before removing an article from and/or loading an article into the storage device and/or whether nothing is removed and/or loaded. In this context, it may be advantageous to store in a memory at which time, in particular on which date and at which time of day, a user removes something from and/or loads something into the storage device. It may also be advantageous that data of the user detection device can be sent to the server and/or retrieved from the server.

A user detection device according to the present disclosure thus serves to obtain information relating to a time a user spends in front of the storage device before deciding to remove and/or load something.

In this context, it may be advantageous that the user detection device is arranged in the upper half, preferably on the front side, of a storage device. In particular, it may be advantageous that the user detection device is arranged in a cover area. A cover area can, for example, be a covering of the storage device that is arranged so as to cover technical equipment above the reach-in area of the storage device.

Also, according to the present disclosure the storage device may comprise at least one storage device parameter, in particular representative of an installation site, a country, a customer group, a dealer, a dealer group, and/or an identification number for unambiguous identification of a particular storage device.

It may also be advantageous that data from the user detection device, the at least one temperature measurement device, the operating state detection device, relating to the storage device parameter and/or from the position detection device is regularly sent to the server and/or retrieved from the server. In this context, the data may be sent to the server and/or become retrievable from the server at intervals, in particular regular intervals, in particular intervals of 30 minutes or 60 minutes.

Also, it may be preferred according to the present disclosure that the storage device is designed in the form of a refrigeration appliance or refrigerator. In this context, the weight of the storage device may in particular not be evaluated when a refrigeration device of the refrigerator is operating. Preferably, the refrigeration appliance is designed in the form of a compressor refrigerator, an absorption refrigerator and/or a thermoelectric refrigerator. In this context, the weight of the refrigerator is in particular not evaluated when a compressor is active.

A refrigeration device, in particular a compressor of a refrigeration device, of a refrigerator causes vibrations that affect a precise measurement of the weight of the storage device. The weight of the refrigerator can thus only be precisely determined when the refrigeration device is not active or if the measuring device is mechanically decoupled from the vibrations of the compressor. A refrigeration device of a refrigerator normally operates at intervals in order to reduce the temperature within a refrigerated area of the refrigerator when it exceeds a predefined threshold. While the temperature is below the threshold, the refrigeration device is not active or not operating. According to the present disclosure, the weight of the storage device is of course not determined either when other devices of the storage device affect the determination of the weight.

If, however, the measuring device is mechanically decoupled from the compressor, measured values can be detected continuously. However, complex technical measures are required to mechanically decouple the measuring device from the compressor in existing refrigeration appliances, whereas it is relatively easy to retrofit existing refrigeration appliances with a measuring device.

Therefore both approaches to improving the measurement accuracy of a measuring device are advantageous.

Also, according to the present disclosure the storage device may have an open storage area, in particular an open refrigerated area, and in particular no door or the like for closing the storage area.

A storage device according to the present disclosure thus allows to precisely determine a removal and/or loading as well as a load state of the storage device, and to determine which articles are located in the storage device and/or removed from or placed in the storage device by measuring the weight of the storage device alone. Furthermore, an operating state, an actual position and/or a temperature of the storage device can be detected and preferably stored and optionally compared with desired values, and a difference from the desired values can be displayed to a user and/or a user can be informed of said difference. The user detection device according to the present disclosure also serves to evaluate user behavior, so that, for example, market research data can be obtained.

According to the present disclosure, a computer network comprising at least one storage device according to the present disclosure and a server may also be provided. Such a computer network according to the present disclosure is preferably in operative connection with at least two storage devices and comprises at least one output device for displaying information or data from the storage devices.

For the purposes of the present disclosure, a computer network means not only a classic computer network comprising at least one computer and preferably at least one server. A computer network according to the present disclosure may also comprise data processing devices and data transmission devices that are, for example, comprised by mobile phones, storage devices, for example, refrigeration appliances, or the like. For example, an exemplary computer network according to the present disclosure may exclusively comprise devices comprising data processing devices, without comprising a conventional computer. A computer network according to the present disclosure may, for example, preferably comprise devices that can provide and/or retrieve data or exchange, receive and/or send data by way of suitable network devices. For the purposes of the present disclosure, the term “computer network” can also mean a combination of data processing device(s) and data transmission device(s), servers, storage device(s), such as refrigerators, and optionally further devices comprising data processing device(s).

In this context, the computer network may advantageously store data from the storage devices after sorting them according to defined parameters, for example, in accordance with a storage device parameter and/or an actual position of the storage devices. This has in particular the advantage that an overview of the installation sites, i.e., the actual positions, of the storage devices can easily be displayed to a user with reduced technical effort and minimal use of resources.

In this context, it may in particular be advantageous that the server receives and/or retrieves data from at least one of the storage devices, in particular automatically, wherein at least one of the storage devices transmits data from a user detection device, a temperature measurement device, an operating state detection device, relating to a storage device parameter and/or from a position detection device to the server, and the data is sorted and/or stored in accordance with an installation site, a country, a dealer, a customer group, a dealer group, and/or an identification number and shown, in particular on an output device, by the server.

A storage device according to the present disclosure and/or a computer network according to the present disclosure thus allow(s) to centrally monitor a plurality of storage devices with simple means, wherein a load state of the storage device, a removal from and/or loading of the storage device and a user behavior can be detected and evaluated, as well as information relating to the operating state, the temperature, the actual position and/or further information of the storage devices.

### DESCRIPTION OF THE DRAWINGS

Further features and advantages of the present disclosure will become apparent from the following description, in which exemplary embodiments of the present disclosure are explained with reference to schematic drawings, by way of example and without limiting the present disclosure.

In the figures:

FIG. 1 shows a perspective view of a storage device according to the present disclosure;

FIG. 2 shows a schematic plan view of a weighing apparatus according to the present disclosure;

FIG. 3 shows a principle view of a storage device according to the present disclosure;

FIG. 4 shows a principle view of a computer network according to the present disclosure having three storage devices according to the present disclosure; and

FIG. 5 shows a schematic plan view of a scanning area of a user detection device according to the present disclosure.

### DETAILED DESCRIPTION

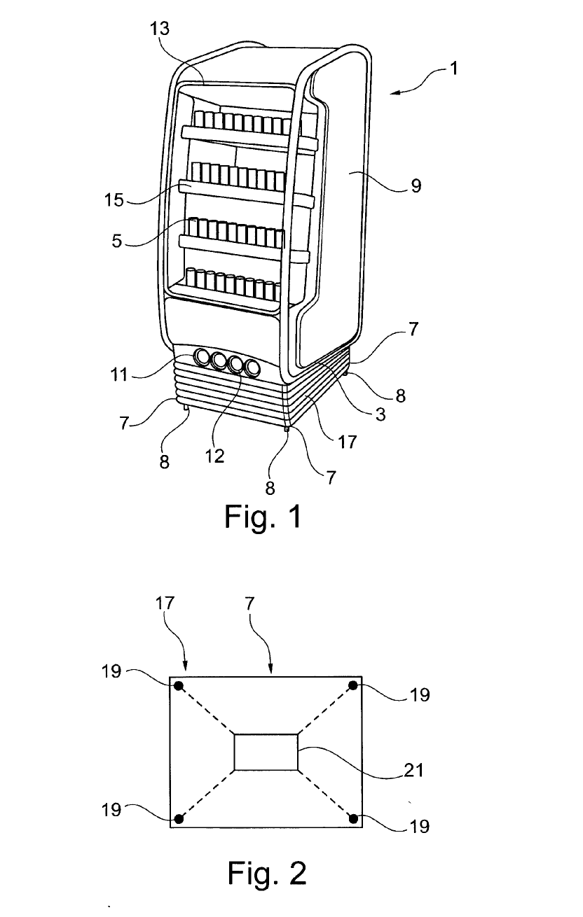

FIG. 1 shows a storage device 1 in the form of a refrigeration appliance. Said storage device 1 has a refrigeration device 3 and a refrigerated area 5 as well as a weighing apparatus 7. As shown, the weighing apparatus 7 can comprise four strain gauges that are arranged underneath the feet 8 or between the feet 8 and the storage device 1.

The weighing apparatus 7 serves to detect the weight of the storage device 1 that is evaluated by an evaluating device (not shown) at defined times. To be able to determine whether an article, which type of article and how many articles is/are removed from the storage device 1 or loaded into the storage device, the measured values of the weighing apparatus are evaluated, wherein the measured values used to determine the weight of the storage device 1 are not evaluated by the evaluating device (not shown) when the measured values of the weighing apparatus 7 are affected by other devices of the storage device 1. In particular, the weight of the storage device 1 is not to be evaluated when the refrigeration device 3 is operating. A refrigeration device 3 normally comprises a compressor (not shown). When the refrigeration device 3 is operating to cool the refrigerated area 5, the compressor will vibrate, thus causing the storage device 1 to vibrate, so that the measured values of the weighing apparatus 7 are distorted. Alternatively, it is of course possible to provide refrigeration devices which do not need a compressor, such as adsorption refrigeration systems. As another alternative, the refrigeration device 3 may be mechanically decoupled from the weighing apparatus 7, so that vibrations of a compressor of the refrigeration device will not affect the measured values of the weighing apparatus 7. To be able to accurately determine the weight of the storage device 1, i.e., according to the present disclosure, no measured values of the weighing apparatus 7 are to be evaluated by the evaluating device (not shown) in this exemplary embodiment using a compressor refrigeration device which is not mechanically decoupled when the refrigeration device 3 is operating or another device of the storage device 1 affects the measured values of the weighing apparatus 7.

Furthermore, the storage device 1 comprises at least one temperature measurement device 9 and a display device 11. The display device 11 is, by way of example, designed in the form of lighting means 12. Of course, additional or alternative display devices may be provided, for example, a display (not shown).

In an upper area of the storage device 1, a user detection device 13 is arranged that detects a user in a defined area in front of the storage device 1. In this context, it can be detected at which time and on which date a user (not shown) spends a particular time period within the user detection device, and whether the user (not shown) removes articles from the storage device 1 and/or places articles in the storage device 1 and if so, how many. In this context, it is preferred that the data of the user detection device 13 is stored in a memory (not shown).

Also, the storage device 1 may have a holding device 15 for articles, in particular a holding device 15 for food items, preferably beverage cans and/or bottles.

According to the present disclosure, it may be advantageous that the storage device 1 has a bottom area 17 where the refrigeration device 3 and/or further devices of the storage device 1, for example, a data processing unit (not shown), is/are arranged.

FIG. 2 shows a schematic plan view of the weighing apparatus 7 according to the present disclosure from FIG. 1. Said weighing apparatus 7 comprises 4 load cells 19 that are arranged below a bottom area 17 of the storage device (not shown in FIG. 2). The weight sensors used can be strain gauges (not shown). Of course, weight sensors other than the strain gauges shown in the figure can also be used. The strain gauges are, by way of example, arranged in the form of a bridge circuit, in particular a Wheatstone bridge, and the measured values of the weighing apparatus 7 or the strain gauges are evaluated by the evaluating device 21 at defined times.

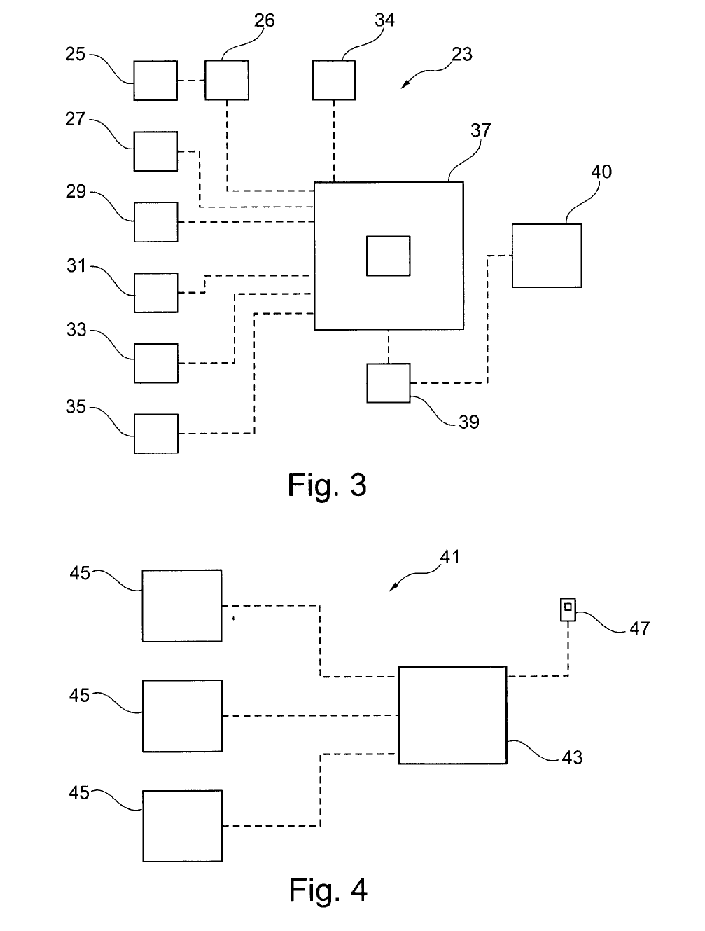

FIG. 3 shows a principle view of a storage device 23 according to the present disclosure. Said storage device 23 comprises a weighing apparatus 25, an evaluating device 26 for evaluating measured values of the weighing apparatus 25, a position detection device 27, a display device 29, a user detection device 31, an operating state detection device 33, an input device 34 and a temperature measurement device 35.

In this context, data from the aforesaid devices 25, 26, 27, 31, 33, 34 and 35 may in particular be processed by a data processing device 37, in particular a computer. Also, the data processing device 37 may be in operative connection with a data transmission device 39, and it may be possible to send information or data from the data processing device 39 to a server 40 and/or retrieve said information or data from the server 40.

FIG. 4 shows a computer network 41 according to the present disclosure having three storage devices 45 according to the present disclosure. Said storage devices 45 comprise at least one data transmission device, so that data or information from the storage devices 45 can be sent to a server 43 and/or retrieved from the server 43. In this context, the server 43 may be in operative connection with at least one further terminal 47, for example, a mobile terminal. Such a computer network 41 according to the present disclosure can make it possible that a plurality of information from storage devices 45 can be displayed to a user with minimal use of resources. In particular, the information can be sorted and displayed in accordance with a particular storage device 45, an installation site of a storage device 45 and/or a plurality of further parameters.

A computer network 41 according to the present disclosure thus allows to centrally detect a load state of storage devices 45 as well as removals from and/or a loading of storage devices 45 in real time, thus obtaining precise information on user behavior. Furthermore, the information can be used to optimize logistics processes, for example, supply chains and supply times, and detailed consumer data can be obtained.

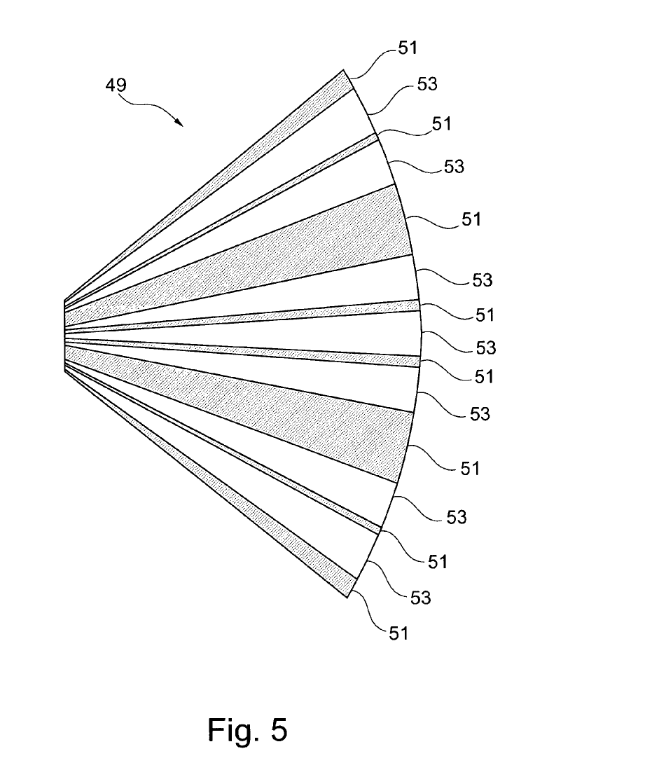

FIG. 5 shows, by way of example, a plan view of a schematic scanning area 49 of a user detection device (not shown) according to the present disclosure. In this context, the storage device (not shown) may in particular comprise a radar module that does not scan particular areas 51 within a scanning area 49 and only evaluates areas 53.

The features of the present disclosure disclosed in the above description, the claims and the drawings can be essential, both individually and in any combination, to implement the present disclosure in its various embodiments.

1. A system comprising:
a storage device for articles; and
a load state detection device, wherein the load state detection device comprises:
at least one weighing apparatus; and
at least one evaluating device,
wherein the at least one weighing apparatus is configured to detect measured values representative of a weight of the storage device, and the at least one evaluating device is configured to determine the weight of the storage device based on measured values of the at least one weighing apparatus detected when the measured values of the at least one weighing apparatus are not affected by devices of the storage device.

2. The system according to claim 1, wherein the at least one weighing apparatus comprises at least one weighing scale.

3. The system according to claim 1, wherein the evaluating device is part of a data processing unit.

4. The system according to claim 1, wherein the at least one weighing apparatus is configured to detect the weight of the storage device within a weighing range from 0 kg to 200 kg with a measurement accuracy in a range from one nanogram to one gram.

5. The system according to claim 1, wherein the at least one weighing apparatus comprises at least one load cell wherein each load cell comprises a strain gauge.

6. The system according to claim 5, wherein the at least one load cell is arranged below the storage device.

7. The system according to claim 1, wherein the load state detection device is configured to determine a load state of the storage device with articles based on the weight of the storage device, wherein the load state detection device is configured to determine, based on a change in weight of the storage device, that an article is removed from the storage device and/or an article is loaded into the storage device.

8. The system according to claim 7, further comprising at least one memory configured to store the time when at least one article is removed from and/or loaded into the storage device.

9. The system according to claim 7, further comprising at least one memory configured to store the number of articles that are removed during a removal and/or the number of articles placed in the storage device when it is loaded.

10. The system according to claim 1, wherein the storage device is configured to store at least one article in the form of a food item.

11. The system according to claim 1, further comprising a data processing device and/or a memory.

12. The system according to claim 1, wherein the storage device comprises a data transmission device configured to transmit data via a wire-based or wireless computer network and/or using a mobile communication standard.

13. The system according to claim 1, wherein the storage device is in operative connection with a server, and the storage device is configured to send data from the storage device to the server and/or to retrieve data from the server, and/or the server is in operative connection with at least one further appliance.

14. The system according to claim 13, further comprising at least one display device, wherein the server is configured to display and/or provide data from the storage device on the display device.

15. The system according to claim 1, wherein the storage device comprises at least one input device and/or the storage device comprises at least one device configured to receive data from an external server.

16. The system according to claim 11, further comprising at least one position detection device.

17. The system according to claim 16, wherein the position detection device is configured to detect a change of an actual position of the storage device and to transmit the actual position of the storage device to a server.

18. The system according to claim 16, wherein the position detection device is configured to compare an actual position of the storage device with a predefined desired position, the system further comprising a display device configured to display a difference between the actual position and the predefined desired position.

19. The system according to claim 16, wherein a desired position of the storage device is stored in the memory and the desired position can be defined and/or changed based on an input to the storage device and/or the server.

20. The system according to claim 11, further comprising an operating state detection device configured to detect an operating state of the storage device.

21. The system according to claim 20, wherein the system is configured to display the operating state of the storage device on a display device, retrieve the operating state of the storage device from the server, and/or send the operating state of the storage device to the server.

22. The system according to claim 20, wherein the operating state detection device is configured to store a desired operating state in the memory, and wherein the desired operating state can be defined and/or changed in accordance with a date and/or a time of day.

23. The system according to claim 20, wherein the data processing device is configured to compare an actual operating state with a predefined desired operating state, the system further comprising a display device configured to display a difference between the actual operating state and the desired operating state.

24. The system according to claim 23, wherein the data processing device is configured to transmit the difference between the actual operating state and the desired operating state to a server, and wherein the server is configured to cause the difference between the actual operating state and the desired operating state to be displayed by a display device.

25. The system according to claim 11, further comprising at least one temperature measurement device configured to detect a temperature in at least one area of the storage device.

26. The storage device system according to claim 25, further comprising a display device configured to display the temperature measured by the at least one temperature measurement device and/or at least one temperature retrieved from the server.

27. The system according to claim 11, further comprising at least one user detection device.

28. The storage device system according to claim 27, wherein the at least one user detection device is configured to scan an area in front of and/or adjacent to a front side of the storage device in front of a reach-in area for removing articles from and/or loading articles into the storage device.

29. The system according to claim 28, wherein the at least one user detection device is arranged in the upper half of the storage device.

30. The system according to 27, wherein the system is configured to retrieve data of the at least one user detection device from an external server and/or send the data of the at least one user detection device to the external server.

31. The system according to claim 27, wherein the at least one user detection device is configured to detect a time period of at least one user in front of the storage device.

32. The system according to claim 27, wherein the at least one user detection device is configured to detect a time period from a start of operation, restart of operation, a previous loading of and/or previous removal from the storage device until the next time when at least one article is removed from and/or loaded into the storage device and/or operation stops, and/or to detect a time period of at least one user in front of the storage device without removal from and/or loading of the storage device, wherein the load state detection device is configured to detect whether something is removed from and/or loaded into the storage device.

33. The system according to claim 1, further comprising a memory configured to store a reference value of a weight of at least one article.

34. The system according to claim 1, wherein the storage device comprises at least one storage device parameter representative of an installation site, a country, a customer group, a dealer, a dealer group, and/or an identification number.

35. The system according to claim 34, wherein the system is configured to transmit to a server and/or retrieve from a server data relating to the at least one storage device parameter and/or from at least one user detection device, the at least one load state detection device, at least one temperature measurement device, at least one operating state detection device, the at least one evaluating device and/or at least one position detection device.

36. The system according to claim 1, wherein the storage device is a refrigeration appliance comprising a refrigeration device.

37. The system according to claim 36, further comprising a data processing device configured to detect and/or store an operating time of the refrigeration device.

38. The system according to claim 1, wherein the at least one evaluating device is configured to determine the weight of the storage device is only when the measured values of the at least one weighing apparatus are not affected by devices of the storage device and/or the at least one evaluating device is configured to compensate for effects of the devices of the storage device on the at least one weighing apparatus.

39. The system according to claim 36, wherein the at least one evaluating device is configured to determine the weight of the refrigeration appliance based on measured values of the at least one weighing apparatus representative of a time when the refrigeration device of the refrigeration appliance is not operating and/or a time when the refrigeration device is mechanically decoupled from the at least one weighing apparatus.

40. The system according to claim 1, wherein the storage device comprises a holding device for food items.

41. The system according to claim 1, wherein the storage device has an open refrigerated area that lacks a door for closing the open refrigerated area.

42. The system according to claim 41, wherein the storage device comprises at least one temperature measurement device configured to detect a temperature in the open refrigerated area.

43. A computer network comprising at least one system according to claim 1 and at least one server.

44. The computer network according to claim 43, wherein the at least one server is in operative connection with at least one input device and/or at least one output device.

45. The computer network according to claim 43, wherein the at least one server is configured to automatically receive and/or retrieve data from the storage device wherein the data received and/or retrieved by the at least one server comprises data from at least one of a user detection device, a temperature measurement device, an operating state detection device, the at least one evaluating device, and/or a position detection device.

46. The computer network according to claim 45, wherein the at least one server is configured to sort and/or store the data received and/or retrieved from the storage device in accordance with an installation site, a country, a customer group, a dealer, a dealer group, and/or an identification number.

47. A method for determining a load state of a storage device for articles, the method comprising:
detecting, by a weighing apparatus, measured values representative of a weight of the storage device; and
determining, by an evaluating device, a weight of the storage device based on the measured values taken when the weighing apparatus is not affected by devices of the storage device.

48. The method according to claim 47, wherein the weight of the storage device is determined within a weighing range from 0 kg to 200 kg with a measurement accuracy in a range from one nanogram to one gram.

49. The method according to claim 47, wherein the weighing apparatus comprises at least one load cell, wherein each load cell comprises at least one strain gauge.

50. The method according to claim 49, wherein the at least one load cell is arranged below the storage device.

51. The method according to claim 47, further comprising:
determining a load state of the storage device based on the weight of the storage device, and
determining, based on a change in weight of the storage device, that an article is removed from the storage device and/or an article is loaded into the storage device.

52. The method according to claim 51, further comprising storing, in a memory, the time when at least one article is removed from and/or loaded into the storage device.

53. The method according to claim 47, further comprising communicating, by a data transmission device, data via a wire-based or wireless communication connection from the storage device to a server and/or communicating data from the server to the storage device.

54. The method according to claim 47, causing, by the server, the data from the storage device to be displayed on a display device.

55. The method according to claim 47, further comprising detecting, by a position detection device, a change of an actual position of the storage device.

56. The method according to claim 55, further comprising:
comparing, by the position detection device and/or the server, the actual position of the storage device with a predefined desired position; and
causing a display device to display a difference between the actual position and the desired position.

57. The method according to claim 55, further comprising storing a desired position of the storage device in a memory.

58. The method according to claim 47, further comprising detecting, by an operating state detection device, an operating state of the storage device.

59. The method according to claim 58, further comprising comparing, by the operating state detection device and/or a server, the operating state of the storage device with a predefined desired operating state.

60. The method according to claim 47, further comprising measuring a temperature of a storage area of the storage device, wherein the temperature is retrieved from the server and/or sent to the server.

61. The method according to claim 47, further comprising:
detecting a time period from a start of operation, restart of operation, a previous loading and/or previous removal until at least one article is removed from and/or loaded into the storage device by the at least one user and/or operation stops is detected, and/or a time period of at least one user in front of the storage device without removal from and/or loading of the storage device; and
detecting, by a load state detection device, a removal from and/or loading of the storage facility.

62. The method according to claim 47, further comprising storing, in a memory, a weight of at least one article as a reference value.

63. The method according to claim 47, further comprising defining at least one storage device parameter for the storage device, wherein the storage device parameter is representative of an installation site, a country, a customer group, a dealer, a dealer group, and/or an identification number.

64. The method according to claim 47, further comprising transmitting and/or retrieving data of at least one of a user detection device, a temperature measurement device, an operating state detection device, and/or a position detection device to and/or from a server.

65. The method according to claim 47, wherein the storage device is a refrigeration appliance, and wherein the refrigeration appliance provides a refrigeration device, the method further comprising:
detecting an operating time of the refrigeration device, wherein the measured values taken when the weighing apparatus is not affected by devices of the storage device are taken when the refrigeration device is not operating to effect refrigeration.

66. The method according to claim 65, wherein the refrigeration appliance is operated using a refrigeration device in the form of a compressor, wherein the refrigeration device is not operating to effect refrigeration when the compressor is not switched on, and/or a digital and/or analogue filter is provided in order to filter the effect of the compressor when the compressor is switched on.

67. The system according to claim 10, wherein the food item is a beverage.

68. The system according to claim 36, wherein the at least one evaluating device is configured to determine the weight of the refrigeration appliance based on measured values of the at least one weighing apparatus that have been filtered using an analogue and/or digital filter configured to filter effects of the refrigeration device on the load state detection device.

69. The method according to claim 58, wherein detecting the operating state of the storage device by the operating state detection device comprises detecting whether the storage device is switched on or switched off, whether maintenance work is due to take place or is taking place and/or the device is malfunctioning or at fault, and wherein the operating state of the storage device is displayed on the storage device by means of the display device and/or is sent to the server and/or retrieved from the server.
